(19) United States
(12) Patent Application Publication
(10) Pub. No.: US 2013/0049395 A1
(43) Pub. Date: Feb. 28, 2013

(54) CARGO AREA EXTENSION SYSTEM METHOD AND APPARATUS

(71) Applicant: Russell Poirier, Weirs Beach, NH (US)

(72) Inventor: Russell Poirier, Weirs Beach, NH (US)

(21) Appl. No.: 13/222,192

(22) Filed: Aug. 31, 2011

(51) Int. Cl. B60R 9/00; B23P 17/00

(52) U.S. Cl. 296/37.6; 29/428

(57) ABSTRACT

An apparatus and method for extending the length of the bed of a pickup truck or other vehicle to increase the overall cargo area of the vehicle and more specifically to a cargo area extension system enclosed in a tailgate of the vehicle that when opened creates an enclosure that attaches to the sidewalls of the vehicle.

### FIELD OF THE INVENTION

The present invention relates to an apparatus and method for extending the length of the bed of a pickup truck or other vehicle to increase the overall cargo area of the vehicle and more specifically to a cargo area extension system enclosed in a tailgate of the vehicle that when opened creates an enclosure that attaches to the sidewalls of the vehicle.

### BACKGROUND OF THE INVENTION

Trucks and other vehicles such as station wagons and sport utility vehicles (SUV) have a rear compartment or cargo area within the vehicle that may be used to haul material(s) such as furniture, construction materials, tools, machinery etc. Commonly, these vehicles have a tailgate at the rear end of the vehicle that opens rearward about a horizontal hinge or axis and lays flat in alignment with the bed platform of the rear compartment, providing access to the cargo area of the vehicle for the loading of materials. The cargo area for the vehicle is defined by the dimensions of the bed platform and sidewalls of the vehicle, with the tailgate in a closed position forming the confines of the cargo area. The size and shape of the materials that may be hauled within the vehicle are limited to this cargo area wherein the tailgate assists in preventing the material from falling out of the cargo area.

As is known in the prior art, some car manufacturers offer a frame extension that can be rotated or extended out onto the flat opened tailgate about an attachment point on the sidewalls of the vehicle. These frame extensions may have rounded horizontal bars with vertical supports acting as a fence which extend the length of the cargo area out and over the tailgate from one sidewall to the other. Other manufacturers offer foldable panels that attach to the sidewalls of the vehicle and that extend out over the open tailgate and mate to create an enclosure and extend the cargo area. While attaching the extension system to the sidewalls allows for the system to be always accessible on the vehicle, when not is use these foldable panels consume cargo area along each of the sidewalls, reducing the available cargo area. What is needed is a cargo area extension system that is transportable, easily accessible and does not reduce the overall cargo space of the vehicle when not in use.

### OBJECT AND SUMMARY OF THE INVENTION

The present invention relates to a cargo area extension system for any vehicle having a cargo area and requiring additional cargo space to haul material(s) for example, furniture, construction materials, tools, machinery, dirt, stone, granulated materials etc.

An object of the present invention is to provide a cargo area extension system that is contained or substantially enclosed within the tailgate of the vehicle, providing easy access and storage of the system without reducing the overall cargo area.

Another object of the invention is to provide a cargo area extension system that when closed is substantially contained within a well of the tailgate and when opened rests on the opened tailgate.

Another object of the present invention is to provide a cargo area extension system having a rear panel hingedly connected with two side panels that affix to the sidewalls and a cover which can at least partially cover the area defined between the rear and side panels.

Another object of the present invention is to provide a cargo area extension kit that may be affixed to the tailgate of an existing vehicle and rests on the tailgate with a rear panel, side panels and cover that affix to the vehicle tailgate and sidewalls in an opened position.

A further object of the invention is to provide a cargo area extension kit that lays flat and may be affixed to the tailgate of a vehicle in a closed position.

A still further object of the present invention is to form the cargo area extension panels of lightweight, durable materials that are easy to lift and maneuver.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a perspective view of a pickup truck vehicle having a cargo area and tailgate;

FIG. 2 is a rear view of a vehicle having a first embodiment of the cargo area extension system within a well of the tailgate of a vehicle;

FIG. 3 is a perspective view of the first embodiment of a cargo area extension system in a closed position within a well of the tailgate of a vehicle;

FIG. 4 is perspective view of the first embodiment of a cargo area extension system in a partially open position resting on the tailgate of a vehicle;

FIG. 5 is perspective view of the first embodiment of a cargo area extension system in an open position resting on the tailgate of a vehicle;

FIG. 6 is perspective view of the first embodiment of a well cover for an embodiment of a cargo area extension system;

FIG. 7A is a perspective view and FIG. 7B is a side view of a first embodiment of an enclosure for a well cover within the tailgate for an embodiment of the cargo area extension system;

FIG. 8A is a perspective view and FIG. 8B is a side view of an embodiment of an attachment mechanism for an embodiment of the cargo area extension system;

FIG. 9 is a perspective view of a vehicle with an embodiment of the cargo area extension system carrying a load;

FIG. 10 is a perspective view of a further embodiment of the cargo area extension for existing vehicles; and

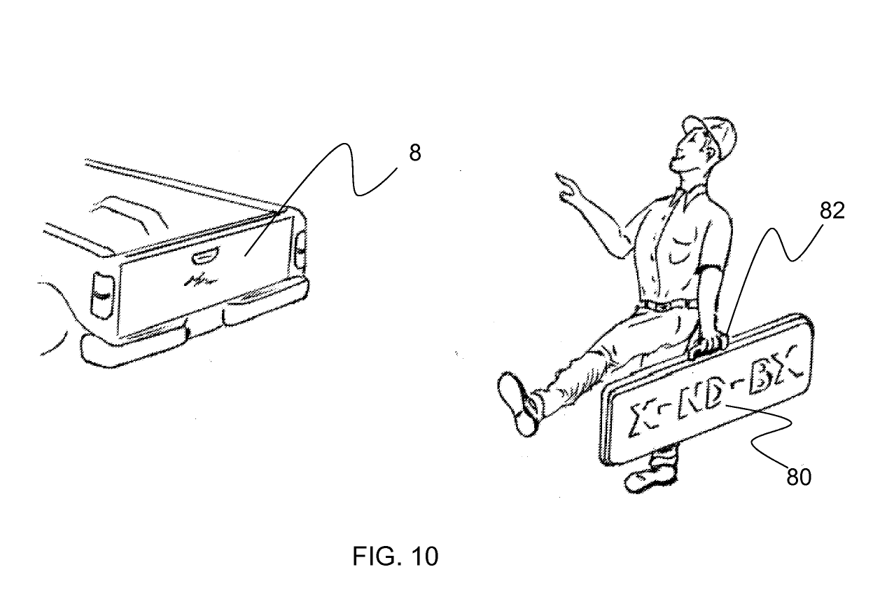

FIGS. 11A and 11B are perspective views of an attachment mechanism for a further embodiment of the cargo area extension system for existing vehicles.

### DETAILED DESCRIPTION OF THE INVENTION

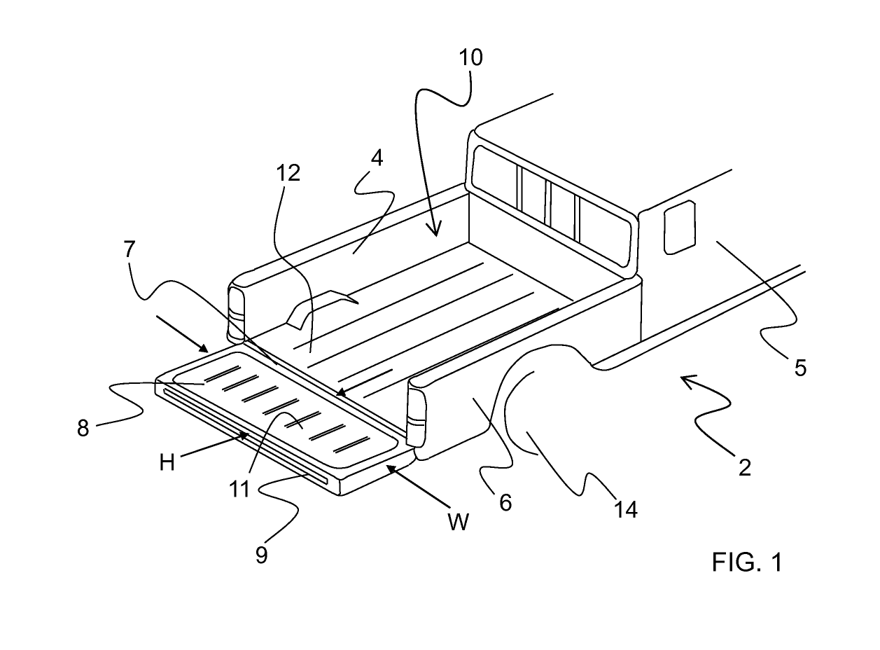

On a pickup truck, a station wagon, a sport utility vehicle or other vehicle, a tailgate is commonly used to provide access to the rear of the vehicle. Using a pickup truck type vehicle 2 as shown in FIG. 1 by way of example, a first and second sidewall 4, 6 extend from a cab 5 or from the front of the vehicle to the tailgate 8 to form a cargo area 10. A bed platform 12 supported by the rear wheels 14 of the vehicle forms the base of cargo area 10 and provides a surface area to load and haul furniture, construction materials, tools, machinery or other items within the cargo area 10 of the vehicle 2. The dimensions of the cargo area 10 and bed platform 12 depend substantially on the design and purpose of the vehicle. Pickup truck vehicles can be different sizes of course, for example a pickup truck may have side walls with a height dimension of around 21 inches and a bed platform length and width of 79 inches×62 inches defining a cargo volume of around 61 cubic feet. Vehicle manufacturers' offer increased cargo volume in some vehicle models by extending the length of the bed platform 12 to, for example, a length of around 98 inches in a pickup of similar dimensions thereby increasing cargo volume to approximately 76 cubic feet.

The tailgate 8 of the vehicle 2 is usually substantially rectangular and hinged along its bottom edge 7 in some manner to the bed platform 12. In a closed position the tailgate is raised so that its side edges engage with the first and second sidewalls 4, 6 of the vehicle to form the cargo area 10 to stow and haul material in the vehicle 2. The tailgate width W would be comparable to the width of the bed platform 12 and the tailgate height H between the bottom edge 7 and a top edge 9 of the tailgate would be comparable to the height of each of the sidewalls 4, 6. A latch or locking mechanism 16 may secure the tailgate 8 in the closed position. In an open position, the tailgate 8 hinges about its bottom edge 7 where it is connected to the base of the bed platform 12 rotating outwards relative to the first and second sidewalls 4, 6 and the cargo area 10 to provide access to the cargo area for loading and unloading of material from the vehicle 2. In the open position the platform of the tailgate 11 provides essentially a flat surface which, as described above, extends the length of the cargo area 10 and lies in substantial horizontal planar alignment with the bed platform 12.

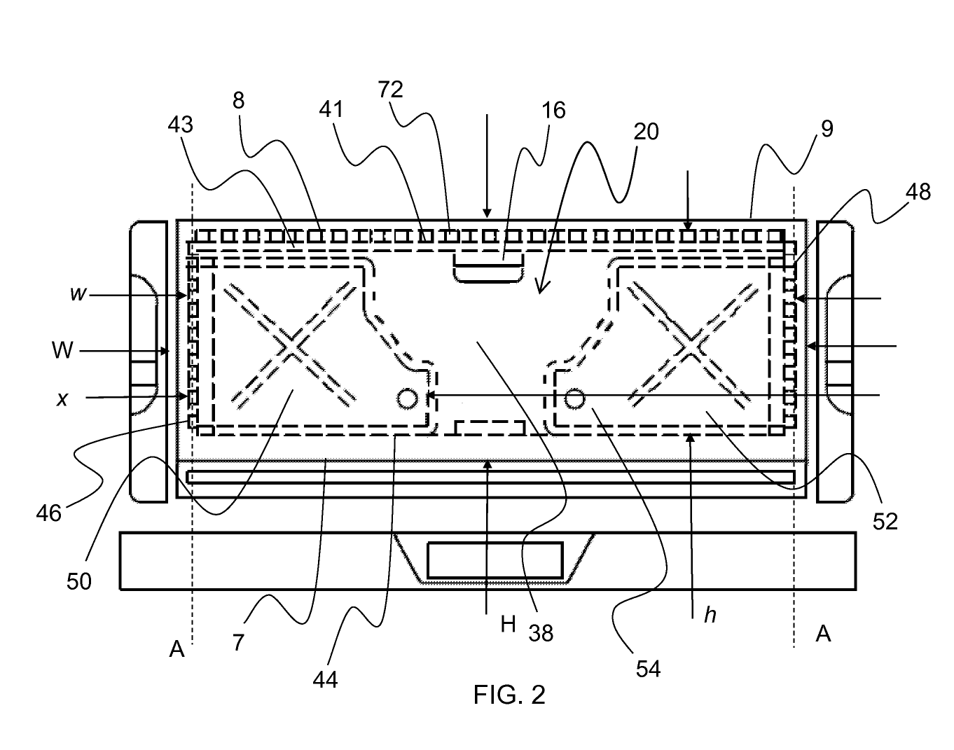

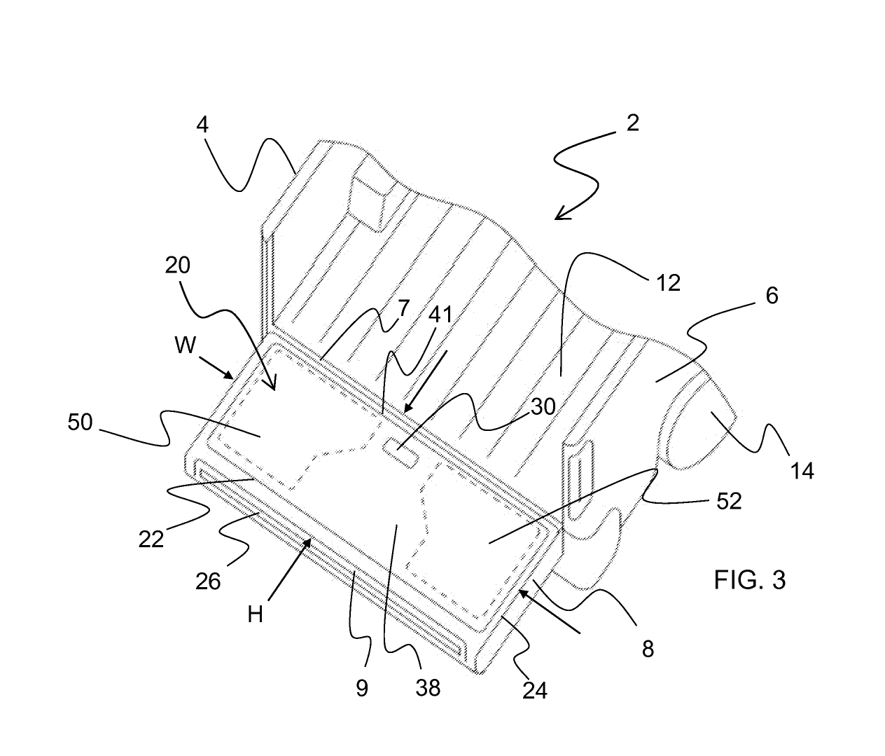

The cargo area extension system 20 of the present invention works in conjunction with the above described tailgate 8 to increase the area and volume of the cargo area 10 of the vehicle 2 as shown in FIG. 2 wherein the extension system 20 is in a closed position aligned with the closed tailgate 8. The extension system 20 includes generally a rear panel 38 being substantially rectangular in shape and having a top edge 43, and a bottom edge 44 defining a height h therebetween. The bottom edge 44 of the rear panel 38 is connected or hinged in some manner to or affixed adjacent, the free end or top edge 9 of the tailgate. The rear panel 38 also includes a first end 46 and a second opposing end 48 between which is defined the width w of the rear panel 38. In this embodiment of the present invention the first and second side panels 50, 52 may be connected or hingedly affixed along an axis A to the first and second ends 46, 48 of the rear panel 38 so that in an open position as seen in FIG. 2 the rear panel 38 and side panels 50, 52 along with the tailgate define contiguous continuation of the sidewalls 4, 6 and a substantially enclosed enlarged cargo area 10 space beyond the end of the bed platform 12. The first and second side panels 50, 52 have a certain degree of freedom to rotate about axis A at each opposing end 46, 48 of the rear panel 38, respectively. Each side panel may be substantially rectangular in shape, having a height h similar to that of the rear panel 38, although other shapes, such as that shown in FIGS. 2 and 3 with a flap or tab 54 and other heights could be contemplated as well. The side panels 50, 52 have a length x somewhat less than half of the width w of the rear panel 38 so that the first and second side panels 50, 52 together are of a dimension smaller than the rear panel 38 and can be easily folded up substantially planar with the rear panel 38 as discussed in detail below.

The side panels 50, 52 may include a flap or tab 54 that provides an attachment point for each of the side panels to be affixed to each of the sidewalls 4, 6 of the cargo area 10. The dimensions and shapes of the side panels 50, 52 and the tab 54 may be formed to accommodate features of the cargo area 10 and sidewalls 4, 6. For example, the flap or tab 54 could extend from a bottom portion of the side panels 50, 52 as well to attach directly to the bed platform 12 of the cargo area 10.

In an embodiment of the present invention the cargo area extension system 20 is integrally incorporated with the tailgate 8 of a pickup truck or other vehicle as shown in FIG. 3 A well 22 is formed in the tailgate 8 to accommodate at least a portion of the cargo area extension system 20. The well 22 has a smaller dimension than the outer dimensions of the tailgate 8 and slightly larger than the extension system 20 in a folded planar configuration. The structural integrity of the tailgate 8 is maintained where the well 22 may be formed with a depth of approximately ½ inch to 3 inches with a depth of about 1 inch to 1¼ inches in depth being preferable. The well is further defined by a border 24 around the well 22 of approximately ½ inch to 3 inches and more preferably about ½ inch to 1½ inches. It is to be appreciated that other acceptable dimensions that accommodate the dimensions of the cargo area extension system 20 as described in further detail below and that are reasonable dimensions to maintain the structural integrity of the tailgate are also contemplated.

The well 22 in the tailgate is designed to accommodate and at least partially house or contain the system 20 when the rear panel 38 and side panels 50, 52 lie substantially coplanar and flat folded into a closed position substantially within the well 22. The rear panel 38 and side panels 50, 52 are folded and placed in and substantially filling the well 22 as shown by dotted lines in a view from the rear of the vehicle in FIG. 2. The rear panel 38 is provided with dimensions to fit within the well formed in the tailgate 8 and in the closed position, the side panels 50, 52 are folded across an inner surface of the end panel 38 so the entire thickness of the folded up rear panel 38 and side panels 50, 52 fits within the depth and length and height dimensions of the well 22 in the tailgate 8.

In contrast to the prior art, the insertion of the cargo area extension system 20 within the well 22 of the tailgate 8 allows the cargo area extension system 20 to be easily accessible, and require no additional volumetric area to be taken from the cargo bed 10 to store the extension system. Further in contrast, the cargo area extension system 20 is always accessible and does not need to be removed to accommodate a first load and then remembered when needed to accommodate a second larger or longer load. In addition to the well 22, a storage slot 26 may be formed in the tailgate 8 to receive and secure a cover 28 that is intended to cover the well 22 and/or further enclose the additional cargo area created when the cargo area extension system 20 is in use.

In a further embodiment of the extension system 20 described above one or more handles or grips 30 are affixed near the upper edge 41 of the rear panel 38 of the cargo area extension system 20. For example the handle 30 may be aligned at a center position relative to the first and second ends 46, 48 of the rear panel 38 cargo area extension system 20. Alternatively two or more handles may be positioned in different positions on the rear panel 38 such as closer to the first and second ends 46, 48. The cargo area extension system 20 may be formed from a lightweight durable composite plastic, fiberglass or other polymer compound.

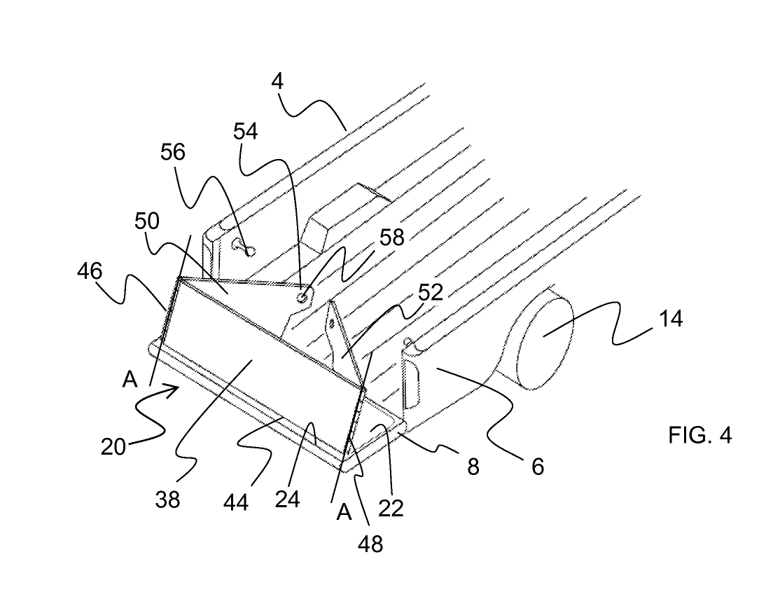

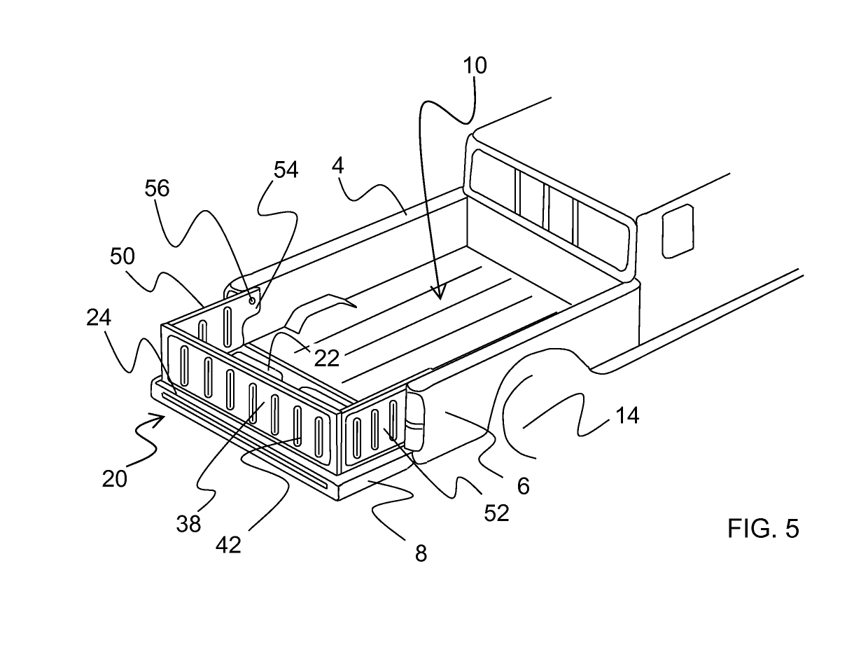

The handle 30 or grip provides for the rear panel 38 of the cargo area extension system 20 to be pulled up and rotated about a hinge for connection of the rear panel 38 with the tailgate 8 as shown in FIG. 4. The bottom edge 44 of the rear panel remains attached to the tailgate 8 and may be connected within or on the edge of the well 22 of the tailgate and may be hingedly affixed to the tailgate 8 to provide for the rear panel 38 to rotate about the bottom edge 44 up and away from the bed platform 12 while remaining within the well 22. Alternatively, the rear panel 38 may be removably attachable or connectable with the tailgate 8 and the cargo area extension system 20 may be pulled up and out of the well 22 as described above, and the bottom edge 44 of the rear panel 38 may be attached along and supported on the rear border 24 of the tailgate 8. The rear panel 38 of the extension system when upright as shown in FIG. 5 will be at a substantially 90 degree angle with respect to the tailgate 8 and thus creates a perpendicular enclosure surface to define the enlarged and extended cargo area over the tailgate 8. An external surface of the extension system 20 may be a continuous surface or may include cutouts, ridges or other elements 42 to reduce weight and/or to provide an aesthetic or decorative element.

The connection of the side panels 50, 52 may be encompassed in a variety of ways, the vehicle sidewall 4, 6 may have a twist, clip, lock, protrusion, knob or other attachment mechanism 56 that may mate with an opening 58 or mating attachment device in the side panel 50, 52 so that when the side panels 50, 52 are swung out and away from the rear panel 38 about axis A, the protrusion, knob or other attachment mechanism 56 may be inserted through the opening 58 as shown in FIG. 5. By twisting, flipping, clamping or other method the attachment mechanism 56 facilitates securing of the side panels 50, 52 to the respective sidewalls 4, 6 forming a three walled enclosure with the first and second side panels 50, 52 and the rear panel 38 defining an enlarged and extended cargo area.

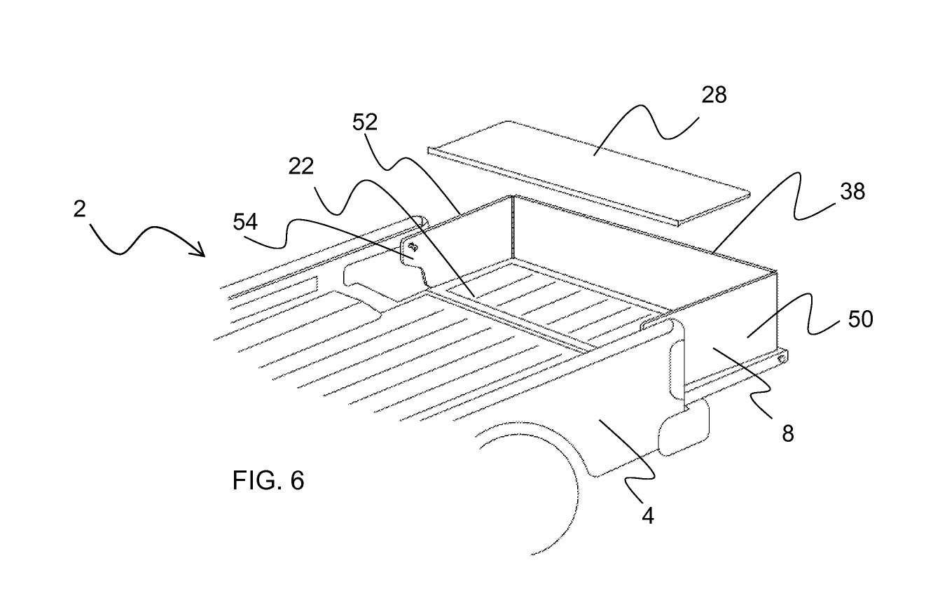

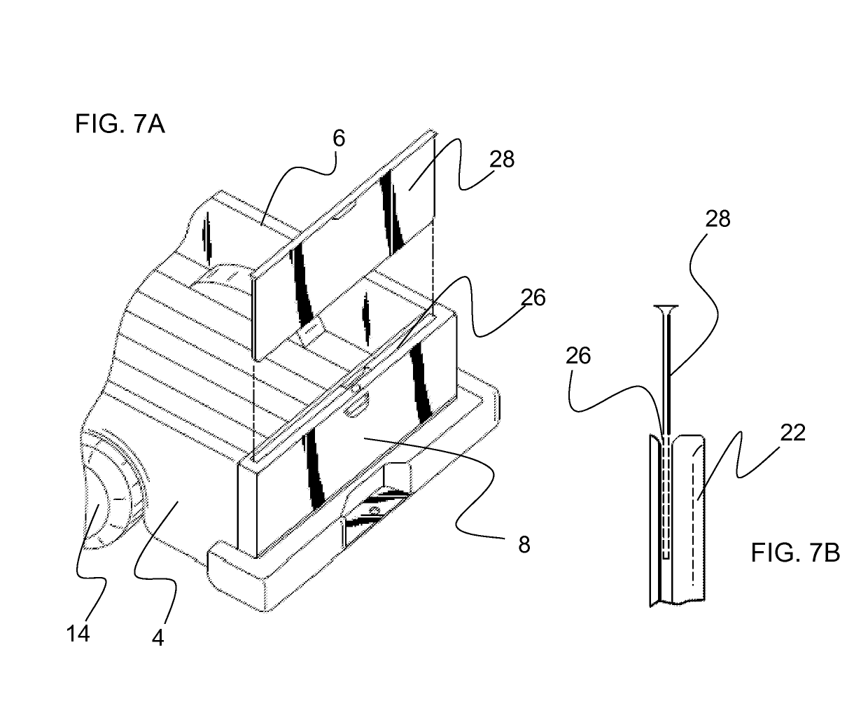

It is to be appreciated that the base of the extended cargo area created by the extension system 20 in an open position is formed by the tailgate 8. A well cover 28 as shown in FIG. 6 may also be provided that is intended to cover the indentation of the tailgate well 22 providing a flat service to more efficiently maintain cargo in an upright position and prevent loss of small items within the well 22. The well cover 28 may be stored within a slot 26 formed within the tailgate 8 as shown in FIGS. 7A and 7B, providing for the well cover 28 to be easily removed prior to opening and folding the tailgate down to a position in alignment with the bed platform 12. The well cover 28 may have a handle or grip to pull the well cover 28 out of the tailgate slot 26 previously described. The well cover 28 and storage slot 26 are of a dimension that provides for the well 22 as shown in FIG. 6B to be of a proper depth to accommodate the cargo area extension system 20 and allow for the structural integrity of the tailgate 8 to remain intact. Alternatively, the well cover 28 may also be attached to the cargo area extension system 20 to be used as a cover for the additional area and volume defined by the extension system 20. The well cover could also be fitted to cover the well 22 when the extension system 20 is folded and substantially enclosed within the well 22 to assist in further retaining the extension system 20 within the well 22 when not in use.

One embodiment of an attachment mechanism 56 with the side panel is shown in FIGS. 7A and 7B. The attachment mechanism 56 has a mounting plate 62 to secure the attachment mechanism to the sidewall 4, 6 of the vehicle 2. An opening 64 may be drilled through the sidewall 4 to insert an attachment spindle 66 from the attachment mechanism 56 through the sidewall 4 and secure the plate 62 using adhesives, screws, bolts or other fixtures. Alternatively, the attachment mechanism 56 may be secured to the inside of the sidewall 4 within the cargo area 10. The attachment spindle 66 may have a rounded prong 68 or knob that is of a slightly smaller dimension than an opening 58 in the side panel 50. A locking clip 70 or twist fixture may extend from the prong 68 and twist, snap or extend and lock into place, thereby preventing the side panel 50 from sliding off of the attachment mechanism 56 due to vibrations of the vehicle 2 in movement or be removed without first unlocking or releasing the locking clip 70. The attachment mechanism 56 is affixed to an appropriate location along the sidewall 4, to prevent interference with fixtures of the sidewall and to properly maintain the side panels 50, 52 in an upright perpendicular position with respect to the bed platform 12, thereby providing the largest interior area within the extension enclosure.

A locking clip, protrusion or knob may alternatively fold out or extend from the extension panel and be secured through a detent, clamp, opening or other attachment device on the sidewall 4, 6 of the cargo area 10. Various attachment mechanisms that secure the side panels 50, 52 to each sidewall 4, 6 and maintain the panels in a vertical position are contemplated. The addition of the enclosure formed by the side panels 50, 52 and the rear panel 38 increases the overall dimensions of the platform and overall volume of the cargo area. For example a rear panel having a width w of 60 inches and each of the extension panels having an extension length of 21 inches would provide 15.3 cubic feet of additional cargo space.

Each side panel 50, 52 may be formed in a single molding production process with the rear panel 38 having a flexible hinge along each of the rotational axes A connecting each side panel to the rear panel. Alternatively, the rear panel 38 and side panels 50, 52 may be formed separately and be mated and attached to the rear panel 38 using a piano type hinge 72 as shown in FIG. 2. In this configuration each mated panel may have alternative cutouts and after mating two appropriate panels a dowel may be inserted through the hinge loops to affix one panel to another. The hinges along each axis A allow each side panel to rotate out from the rear panel and around the axis. The molding process may also provide for the formation of a depression for each extension panel 50, 52 to be inserted within the rear panel 38. The depressions reduce the overall weight and thickness of the cargo area extension system 20. The depressions may be of any shape and dimensions that accommodate the shape and dimension of the side panels 50, 52. The well cover 28 may be removably affixed to the rear panel 38 and form a tailgate cover when the cargo area extension system 20 is not in use.

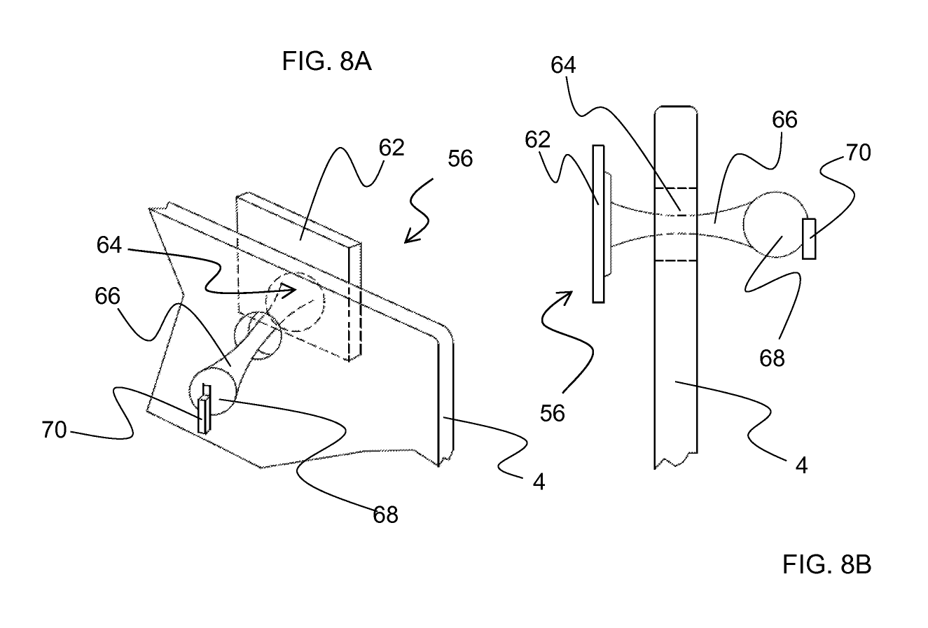

As shown in FIG. 8, the cargo area extension 20 may be of a solid piece without openings that provide a contiguous surface similar to the sidewalls 4, 6 to provide for the hauling of bulky loads 76 of dirt, stone or gravel and prevent the loss of any of the load through a gap in the rear or side panels. Conventional extension systems commonly are formed as frames or partial rings to reduce the overall weight of the extension system limiting the usefulness of the extension system when hauling small or granulated materials. By enclosing the cargo area extension system 20 within the tailgate 8 and easily pulling up on the rear panel 38 and extending the sides 50, 52 there is no requirement to lift the cargo area extension system 20 up and out of the vehicle 2 when not in use or when additional cargo space within the platform is required.

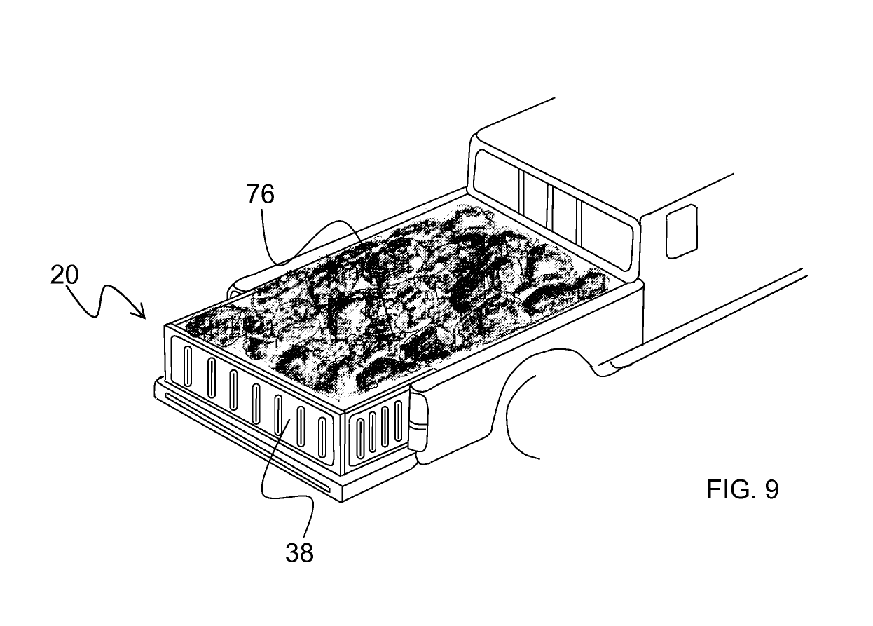

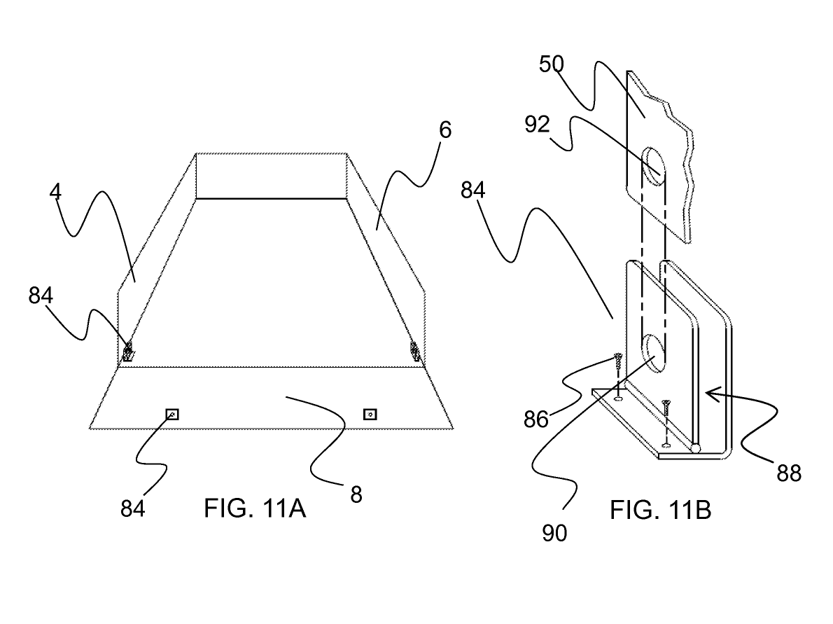

In a further embodiment the cargo area extension system, the system may be a portable extension kit 80 that easily folds flat and may be carried by a handle 82 as shown in FIG. 9. The side panels 50, 52 fold flat against or into a depression within the rear panel 38 and are locked in place. The handle 82 may form a latch when the side panels 50, 52 are closed. In operation the cargo area extension kit in a closed position is placed on an opened tailgate 8. The side panels 50, 52 are affixed to the rear panel along a hinge 72 and are swung out from the rear panel 38 along the axes A as described above. An attachment mechanism 56 on either the vehicle or the side panel 50, 52 and a locking mechanism 70 on the opposing surface of the vehicle 2 or the panel are mated to secure each of the side panels 50, 52 to the sidewalls 4, 6 of the vehicle. As previously described, using the kit an enclosure is formed that increases the overall cargo area of the vehicle. One or more fastening clips 84 as shown in FIGS. 11A and 11B that may be included in the kit may be affixed to the sidewalls 4, 6, bed platform 14, or tailgate 8 to align and secure the cargo area extension kit system 80 to the vehicle 2. The clips 84 may be attached with small fastening screws 86 minimizing any deformation or blemish to the exterior or interior surface of the vehicle 2. For example the attachment clip 84 may form a slot 88 for each panel of the cargo area extension kit system 80 to be inserted into and then an opening 90 and locking mechanism 92 such as a spindle, nub or protrusion may secure the panel 50 to the vehicle 2. The clips 84 may lay flat when not in use thereby reducing the amount of interior space of the vehicle 2 such as station wagon or SUV that is used. The clips 84 may also secure the cargo area extension kit system 80 in a flat closed position to the tailgate 8 when not in use. Other attachment methods are contemplated as previously described with the advantage of a cargo area extension kit 80 providing increased cargo area for existing vehicles with minimal modifications to the vehicle and minimal cargo area consumed by the kit when not in use.

The invention has been described in detail with particular reference to certain preferred embodiments thereof, but it will be understood that variations and modifications can be effected within the spirit and scope of the invention.

What is claimed is:

1. A cargo area extension system, comprising:
a rear panel having a first and second end;
a first and second side panel connected to the first and second ends of the rear panel, respectfully;
a well within the volumetric area of a tailgate of a vehicle; and
wherein in a closed position the rear panel and first and second side panels fold flat and are enclosed within the well within the volumetric area of the tailgate and in an open position the rear panel and first and second side panels unfold and rest on the tailgate to form an enclosure to extend the cargo area of the vehicle.

2. The cargo area extension system of claim 1 wherein the first and second side panels are hingedly connected to the first and the second ends of the rear panel, respectfully.

3. The cargo area extension system of claim 1 wherein the rear panel is hingedly connected to the tailgate of the vehicle.

4. The cargo area extension system of claim 1 wherein in an open position the first and second side panels releasably attach to a first and second sidewall of the vehicle, respectfully.

5. The cargo area extension system of claim 1 further comprising a cover wherein in an open position the cover rests over the well.

6. The cargo area extension system of claim 5 wherein the cover is concealed in a slot within the volumetric area of the tailgate.

7. A method for forming a cargo area extension system, comprising the steps of:
forming a rear panel substantially of the same dimensions as the tailgate of a vehicle, the rear panel having a first and second end;
affixing a first and second side panel to the first and second ends of the rear panel, respectfully;
forming a depression within the tailgate of a vehicle of substantially the dimensions of the rear panel and of a depth substantially of the thickness of the rear panel and the first and second side panels;
laying the rear panel and first and second side panels within the depression within the tailgate of the vehicle in a closed position; and
extending the rear panel and first and second side panels to form an enclosure to extend the cargo area of the vehicle in an open position.

8. The method for forming a cargo area extension system of claim 7 further comprising the steps of hingedly affixing the first and second side panels to the rear panel.

9. The method for forming a cargo area extension system of claim 7 further comprising the steps of hingedly affixing the rear panel to the tailgate of the vehicle.

10. The method for forming a cargo area extension system of claim 7 further comprising the steps of releasably attaching the first and second side panels to a first and second sidewall of the vehicle.

11. The method for forming a cargo area extension system of claim 7 further comprising the steps of forming a cover that substantially covers the depression formed within the tailgate of the vehicle.

12. The method for forming a cargo area extension system of claim 7 further comprising the steps of concealing the cover within a slot formed within the volumetric area of the tailgate of the vehicle.

13. A method for forming a cargo area extension system for a vehicle including a kit for forming an enclosure comprising the steps of:
providing in a kit a rear panel and a first and second side panel affixed to a first and second end of the rear panel;
providing in the kit at least one attachment mechanism; and
wherein in a closed position the first and second side panels are folded against the rear panel and in an open position the rear panel and first and second side panels rest on the tailgate of a vehicle and each of the first and second side panels are releasably attached to a first and second sidewall of a vehicle.

14. The method for forming a cargo area extension system for a vehicle including a kit for forming an enclosure of claim 13 further comprising the steps of affixing a handle to at least one of the rear panel and/or the first and second side panels.

15. The method for forming a cargo area extension system for a vehicle including a kit for forming an enclosure of claim 13 further comprising the steps of releasably securing the at least one attachment mechanism to the folded rear panel and first and second side panels in a closed position.
